(19) United States
(12) Patent Application Publication
(10) Pub. No.: US 2018/0367005 A1
(43) Pub. Date: Dec. 20, 2018

(54) STATOR ASSEMBLY WITH UNEVEN CONDUCTORS

(71) Applicant: GM GLOBAL TECHNOLOGY OPERATIONS LLC, Detroit, MI (US)

(72) Inventors: Khwaja M. Rahman, Troy, MI (US); Jingchuan Li, Troy, MI (US)

(73) Assignee: GM GLOBAL TECHNOLOGY OPERATIONS LLC, Detroit, MI (US)

(21) Appl. No.: 15/622,391

(22) Filed: Jun. 14, 2017

(51) Int. Cl. H02K 3/28; H02K 3/12

(52) U.S. Cl. CPC H02K 3/28; H02K 3/12

(57) ABSTRACT

A stator assembly includes a plurality of stator slots, including a first stator slot defining a slot axis. A plurality of conductors is at least partially positioned in the first stator slot and forms a winding set. The assembly is characterized by uneven conductor lengths and a combination of series and parallel connections in the coil sets of the winding set. The winding set includes at least one coil set with the conductors connected in series and at least one coil set with the conductors connected in parallel. At least one of the conductors extends a first conductor length along the slot axis and at least another of conductors extends a second conductor length along the slot axis. The first conductor length is different from the second conductor length. The assembly results in reduced winding alternating current losses, enhanced motor torque and additional turn count options.

### INTRODUCTION

The disclosure relates generally to a stator assembly, and more particularly, to the configuration of the conductors in the stator assembly. An electric machine typically includes a stator having a plurality of stator windings and a rotor rotatable within the stator. In a generator mode, the rotation of the rotor induces voltage in the stator winding, which powers an external load such as charging a battery pack. Alternately, if an electric current is passed through the stator windings, the energized coils may cause the rotor to rotate and the machine will perform as a motor. The turn count of a stator assembly is limited due to a variety of reasons. Additionally, the assembly may produce winding alternating current losses.

### SUMMARY

A stator assembly includes a plurality of stator slots, including a first stator slot defining a slot axis. A plurality of conductors (referred to as “conductors” henceforth) is at least partially positioned in the first stator slot and forms a winding set. The assembly is characterized by uneven conductor lengths and a combination of series and parallel connections in the coil sets of the winding set. The winding set includes at least one coil set with the conductors connected in series and at least one coil set with the conductors connected in parallel. At least one of the conductors extends a first conductor length along the slot axis and at least another of the conductors extends a second conductor length along the slot axis. The first conductor length is different from the second conductor length. The assembly results in reduced winding alternating current losses, enhanced motor torque and additional turn count options.

The plurality of conductors may include first, second, third, fourth, fifth, sixth, seventh and eighth conductors. In a first embodiment, the first, second, third and fourth conductors each extend the first conductor length along the slot axis, while the fifth, sixth, seventh and eighth conductors each extend the second conductor length along the slot axis. In a second (and a fourth) embodiment, the first through sixth conductors each extend the first conductor length along the slot axis, and the seventh and eighth conductors each extend the second conductor length along the slot axis. In a third embodiment, the first through fourth conductors each extend the first conductor length, the fifth and sixth conductors each extend the second conductor length, and the seventh and eighth conductors each extend a third conductor length. The third conductor length is different from the first and second conductor lengths.

The winding set may include a first coil set with the first and second conductors connected in series and a second coil set with the third and fourth conductors connected in series. In a first embodiment, the winding set further includes a third coil set with the fifth and sixth conductors connected in parallel and a fourth coil set with the seventh and eighth conductors connected in parallel. In a second and third embodiment, the winding set includes a third coil set with the fifth and sixth conductors connected in series and a fourth coil set with the seventh and eighth conductors connected in parallel. In a fourth embodiment, the winding set includes a third coil set with the fifth and sixth conductors connected in parallel and a fourth coil set with the seventh and eighth conductors connected in parallel.

The assembly may include uneven stator slot that are narrower near slot openings, resulting in reduced levels of tooth saturation. The assembly may include a first stator slot positioned adjacent to a first stator tooth. The first stator slot has a first slot portion and a second slot portion such that the second slot portion is radially outwards of the first slot portion. The first slot portion defines a first slot width substantially perpendicular to the slot axis. The second slot portion may define a second slot width substantially perpendicular to the slot axis such that the first slot width is smaller than the second slot width.

The first stator slot may have a third slot portion positioned radially outwards of the second slot portion, such that the third slot portion defines a third slot width substantially perpendicular to the slot axis. The second slot width may be smaller than the third slot width.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic fragmentary cross-sectional view of a stator assembly in accordance with a first embodiment;

FIG. 2 is a schematic diagram of electrical connections for the assembly of FIG. 1;

FIG. 3 is an example winding layout for the electrical connections shown in FIG. 2;

FIG. 4 is a schematic fragmentary cross-sectional view of a stator assembly, in accordance with a second embodiment;

FIG. 5 is a schematic diagram of electrical connections for the assembly of FIG. 4;

FIG. 6 is a schematic fragmentary cross-sectional view of a stator assembly in accordance with a third embodiment;

FIG. 7 is a schematic diagram of electrical connections for the assembly of FIG. 6;

FIG. 8 is a schematic fragmentary cross-sectional view of a stator assembly in accordance with a fourth embodiment; and

FIG. 9 is a schematic diagram of electrical connections for the assembly of FIG. 8;

FIG. 10 is an example winding layout for the electrical connections shown in FIG. 9.

### DETAILED DESCRIPTION

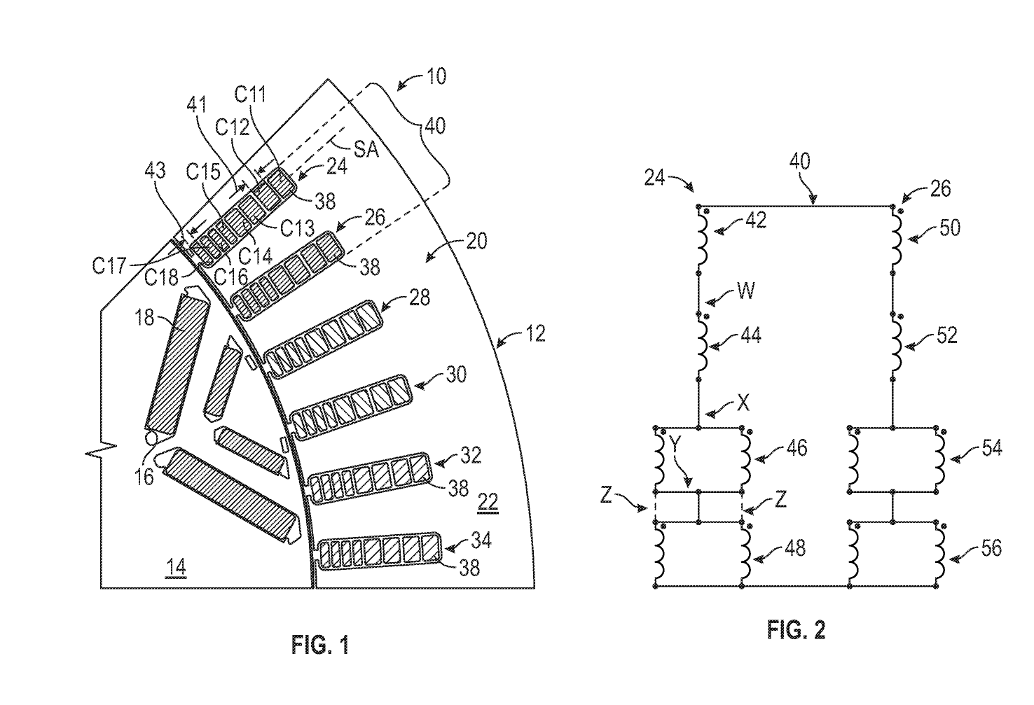

Referring to the FIGS., wherein like reference numbers refer to the same or similar components throughout the several views, FIG. 1 is a schematic cross-sectional view of a portion of a stator assembly 10, which may be part of an electric machine 12. The machine 12 may include a device configured to generate an electric machine torque by, for example, converting electrical energy into rotational motion. The machine 12 may be configured to receive electrical energy from a power source, such as a battery array (not shown), to generate rotational motion. The machine 12 may be further configured to generate electrical energy when provided with mechanical energy, such as the mechanical energy (torque) of an engine.

Referring to FIG. 1, the machine 12 includes a rotor 14 that is rotatable relative to and within the assembly 10 about a longitudinal axis (not shown, extends out of the page in FIG. 1). The rotor 14 may be annularly-shaped. In one example, the rotor 14 includes multiple rotor slots 16 having a portion or the entirety filled with permanent magnets 18. The rotor 14 may include but is not limited to, an interior permanent magnet, a surface permanent magnet, an induction, synchronous, reluctance or a separately-excited/wound-field rotor.

Referring to FIG. 1, the assembly 10 includes a plurality of stator slots 20 extending away from a stator core 22. Referring to FIG. 1, the plurality of stator slots 20 (“plurality of” omitted henceforth) includes a first stator slot 24, second stator slot 26, third stator slot 28, fourth stator slot 30, fifth stator slot 32 and sixth stator slot 34. The stator slots 20 may extend lengthwise along the longitudinal axis and may be evenly spaced from each other circumferentially. While in the embodiment shown, the stator slots 20 are partially open slots, the stator slots 20 may also be closed or fully opened slots. Each of the stator slots 20 defines a respective slot axis. For example, the first stator slot 24 defines a slot axis SA. It is understood that the assembly 10 may include whatever number of slots or poles suitable to the application at hand.

Referring to FIG. 1, the assembly 10 includes hairpins or conductors 38 configured to allow a current to flow from a respective first leg in one of the stator slots 20 to a respective second leg in another of the stator slots 20. The conductors 38 may include a substantially rectangular cross-section. Other cross-sectional shapes may be employed. It is understood that the conductors 38 shown in FIG. 1 are only schematic, and are not meant to represent the scale or specific shape of the conductors 38 as understood by those skilled in the art. Stator slot liners (not shown) may be inserted within the stator slots 20 to electrically isolate the conductors 38 from the stator core 22 and from one another.

The conductors 38 that are positioned in the first stator slot 24 and second stator slot 26 at least partially form a winding set 40. FIG. 2 is a schematic example of electrical connections for the winding set 40. In one embodiment, the winding set 40 defines one of three identical phases. In another embodiment, the winding set 40 defines one of five identical phases. The machine 12 is not limited to a three or five phase machine, and the number of phases may differ from the phases described herein.

As described below, the assembly 10 is characterized by uneven conductor lengths and a combination of series and parallel connections in the coil sets of the winding set 40. Referring to FIG. 1, at least one of the conductors 38 defines a first conductor length 41 (along the slot axis SA) and at least another of the conductors 38 defines a second conductor length 43 (along the slot axis SA). The first conductor length 41 is different from the second conductor length 43. Providing uneven conductors in the assembly 10 allows for additional turn count options.

Referring to FIG. 1, the first stator slot 24 includes first, second, third, fourth, fifth, sixth, seventh and eighth conductors C11, C12, C13, C14, C15, C16, C17, C18, respectively. In the first embodiment shown in FIG. 1, the first, second, third and fourth conductors C11, C12, C13, C14 each extend the first conductor length 41 along the slot axis SA, while the fifth, sixth, seventh and eighth conductors C15, C16, C17, C18 each extend the second conductor length 43 along the slot axis SA.

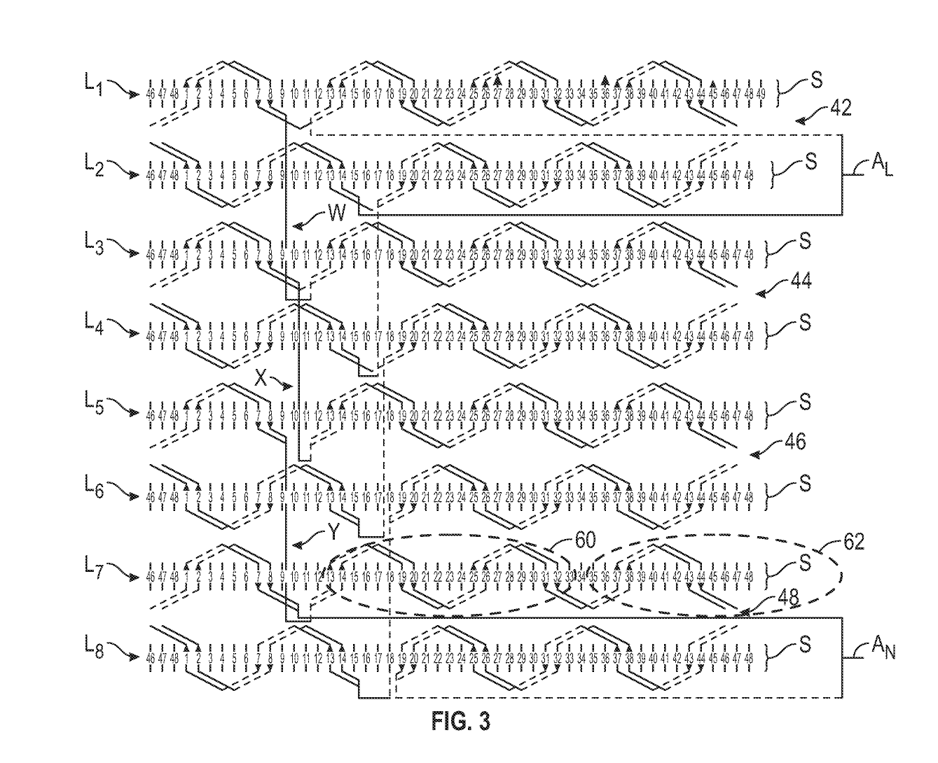

Referring to FIG. 2, the winding set 40 includes a first coil set 42, a second coil set 44, third coil set 46 and a fourth coil set 48. The winding set 40 includes at least one coil set with the conductors 38 connected in series and at least one coil set with the conductors 38 connected in parallel. This configuration of the assembly 10 results in reduced winding alternating current losses, allowing the tailoring of motor torque-speed performance to the target requirements by providing additional turn count options. Referring to FIGS. 1-2, the first coil set 42 has the first and second conductors C11, C12 connected in series resulting in 8 turns (C11 connects to C12 but in another slot in the next pole, not the same slot). The second coil set 44 has the third and fourth conductors C13, C14 connected in series, resulting in 8 turns. The third coil set 46 has the fifth and sixth conductors C15, C16 connected in a set of two parallel branches, resulting in 4 turns. The fourth coil set 48 has the seventh and eighth conductors C17, C18 connected in a set of two parallel branches, resulting in 4 turns. Thus the total turn count in this embodiment is 24. The winding set 40 may include a fifth coil set 50, sixth coil set 52, seventh coil set 54 and eight coil set 56, having a similar configuration. In this embodiment, the first coil set 42 is connected in series (see connection W in FIGS. 2-3) to the second coil set 44. The second coil set 44 is connected in series (see connection X in FIGS. 2-3) to the third coil set 46. The third coil set 46 (having the fifth and sixth conductors C15, C16 connected in parallel) is connected in series (see connection Y in FIGS. 2-3) to the fourth coil set 48 (having the seventh and eighth conductors C17, C18 connected in parallel). Alternatively, the third coil set 46 and the fourth coil set 48 may be combined to have two parallel branches (see connection Z in FIG. 2) such that the fifth conductor C15 and the seventh conductor C17 form one of the two parallel branches and the sixth conductor C16 and the eighth conductor C18 form the other of the two parallel branches.

FIG. 3 is a schematic diagram of an example winding layout for the winding set 40, corresponding to the electrical connections shown in FIG. 2. While FIG. 3 indicates 48 stator slots in total, it is understood that the number of slots may be varied. The slot numbers are bracketed on the right by the letter “S” (such that numbers 1 through 48 refer to each stator slot), with the right side of the figure wrapping over or joining the left side of the figure. FIG. 3 shows the first through eighth conductor layers L₁, L₂, L₃, L₄, L₅, L₆, L₇ and L₈. While the winding layout in FIG. 3 is shown for a single phase, the layouts for other phases are similar. The letters “A_{L}” and “A_{N}” in FIG. 3 refer to a phase A lead and a phase A neutral connection, respectively. Alternative configurations may be made, for example, a “Y” configuration without a common neutral or a Delta connection, as understood by those skilled in the art.

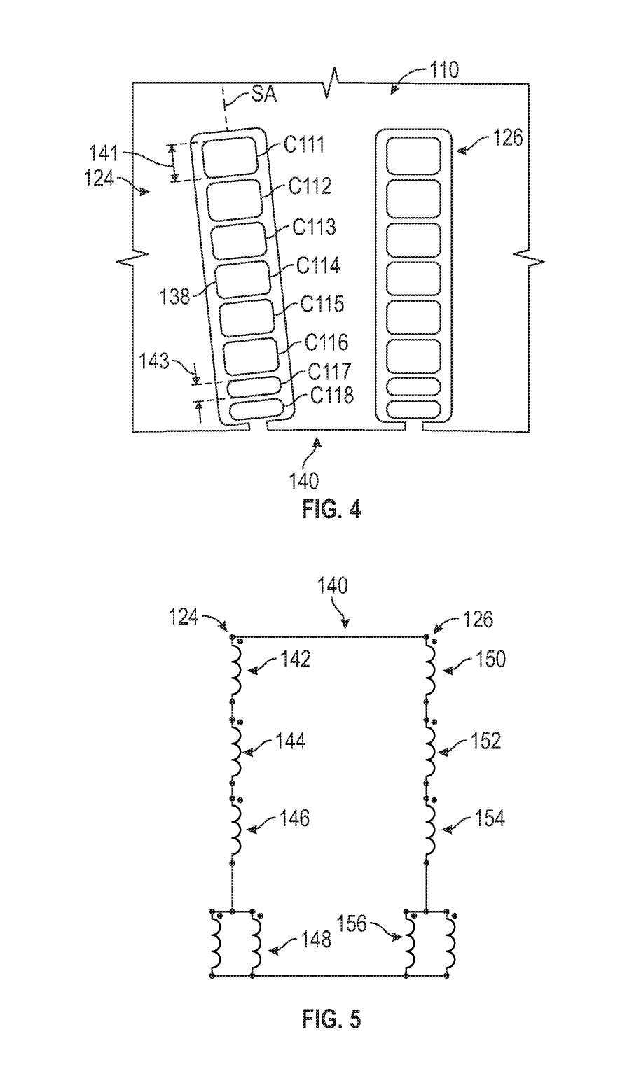

A second embodiment is shown in FIGS. 4-5. Referring to FIG. 4, the stator assembly 110 includes conductors 138 positioned in first and second stator slots 124, 126, and forming a winding set 140. The assembly 110 is characterized by uneven conductor lengths and a combination of series and parallel connections in the coil sets of the winding set 140. Referring to FIG. 4, the first through sixth conductors C111, C112, C113, C114, C115, C116, each extend a first conductor length 141 along the slot axis SA. The seventh and eighth conductors C117, C118 each extend the second conductor length 143 along the slot axis SA.

Referring to FIG. 5, the winding set 140 includes a first coil set 142, a second coil set 144, third coil set 146 and a fourth coil set 148. The winding set 140 includes at least one coil set with the conductors 138 connected in series and at least one coil set with the conductors 138 connected in parallel. Referring to FIGS. 4-5, the first coil set 142 has the first and second conductors C111, C112 connected in series (C111 connects to C112 but in another slot, not the same slot), resulting in 8 turns. The second coil set 144 has the third and fourth conductors C113, C114 connected in series, resulting in 8 turns. The third coil set 146 has the fifth and sixth conductors C115, C116 connected in series, resulting in 8 turns. The fourth coil set 148 has the seventh and eighth conductors C117, C118 connected in a set of two parallel branches, resulting in 4 turns. Thus the total turn count in the second embodiment is 28. The winding set 140 may include a fifth coil set 150, sixth coil set 152, seventh coil set 154 and eight coil set 156, having a similar configuration.

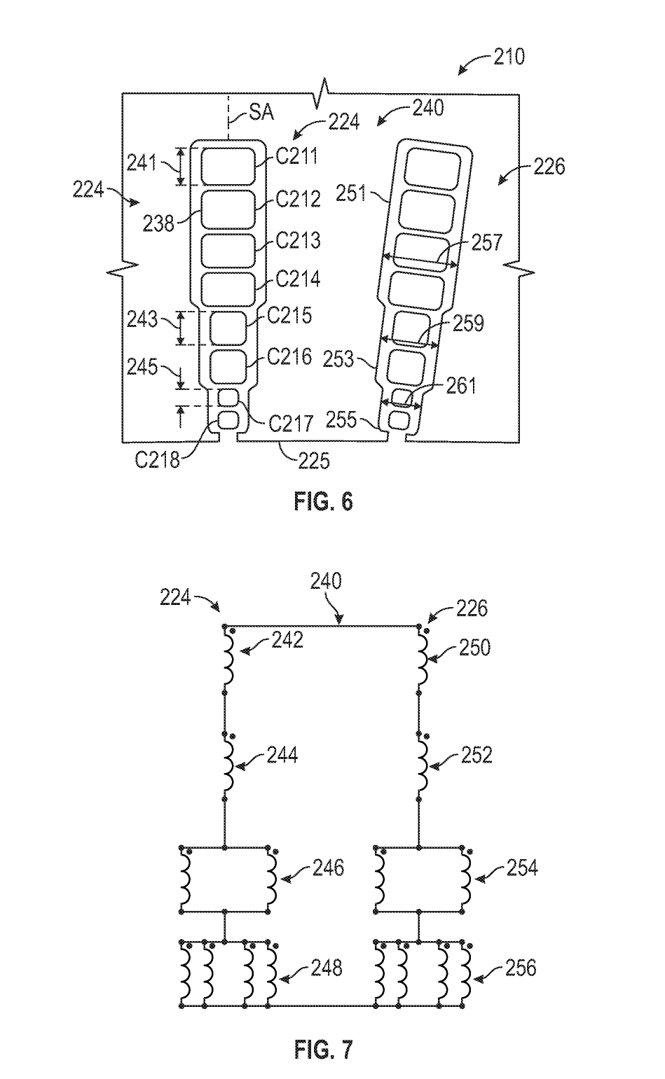

A third embodiment is shown in FIGS. 6-7. Referring to FIG. 6, the stator assembly 210 includes conductors 238 positioned in first and second stator slots 224, 226, and forming a winding set 240. The assembly 210 is characterized by uneven conductor lengths and a combination of series and parallel connections in the coil sets of the winding set 240. Referring to FIG. 6, the first through fourth conductors C211, C212, C213, C214 each extend a first conductor length 241 along the slot axis SA. The fifth and sixth conductors C215, C216 each extend the second conductor length 243 along the slot axis SA. The seventh and eighth conductors C217, C218 each extend the third conductor length 245 along the slot axis SA. The third conductor length 245 is different from the first and second conductor lengths 241, 243. The conductors 238 may have different widths as well.

Referring to FIG. 7, the winding set 240 includes a first coil set 242, a second coil set 244, third coil set 246 and a fourth coil set 248. The winding set 240 includes at least one coil set with the conductors 238 connected in series and at least one coil set with the conductors 238 connected in parallel. Referring to FIGS. 6-7, the first coil set 242 has the first and second conductors C211, C212 connected in series, resulting in 8 turns. The second coil set 244 has the third and fourth conductors C213, C214 connected in series, resulting in 8 turns. The third coil set 246 has the fifth and sixth conductors C215, C216 connected in a set of two parallel branches, resulting in 4 turns. The fourth coil set 248 has the seventh and eighth conductors C217, C218 connected in a set of four parallel branches, resulting in 2 turns. Thus the total turn count in the third embodiment is 22. The winding set 240 may include a fifth coil set 250, sixth coil set 252, seventh coil set 254 and eight coil set 256, having a similar configuration.

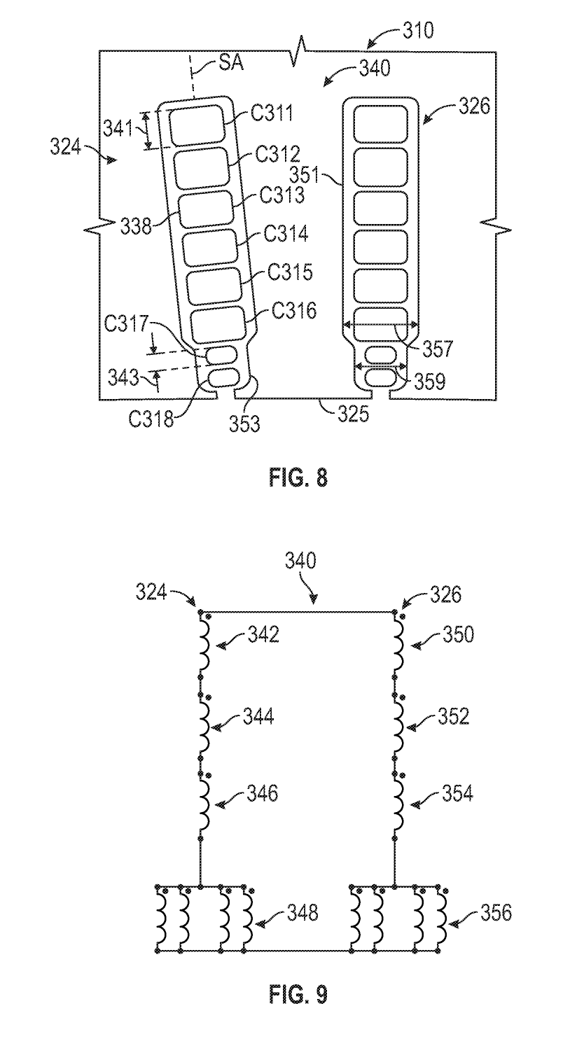

A fourth embodiment is shown in FIGS. 8-9. Referring to FIG. 8, the stator assembly 310 includes conductors 338 positioned in first and second stator slots 324, 326, and forming a winding set 340. The assembly 310 is characterized by uneven conductor lengths and a combination of series and parallel connections in the coil sets of the winding set 340. Referring to FIG. 8, the first through sixth conductors C311, C312, C313, C314, C315, C316 each extend a first conductor length 341 along the slot axis SA. The seventh and eighth conductors C317, C318 each extend the second conductor length 343 along the slot axis SA.

Referring to FIG. 9, the winding set 340 includes a first coil set 342, a second coil set 344, third coil set 346 and a fourth coil set 348. The winding set 340 includes at least one coil set with the conductors 338 connected in series and at least one coil set with the conductors 338 connected in parallel. Referring to FIG. 9, the first coil set 342 has the first and second conductors C311, C312 connected in series. The second coil set 344 has the third and fourth conductors C313, C314 connected in series. The third coil set 346 has the fifth and sixth conductors C315, C316 connected in series, contributing eight turns. The fourth coil set 348 has the seventh and eighth conductors C317, C318 connected in a set of four parallel branches, resulting in 2 turns. Thus the total turn count in this embodiment is 26. The winding set 340 may include a fifth coil set 350, sixth coil set 352, seventh coil set 354 and eight coil set 356, having a similar configuration.

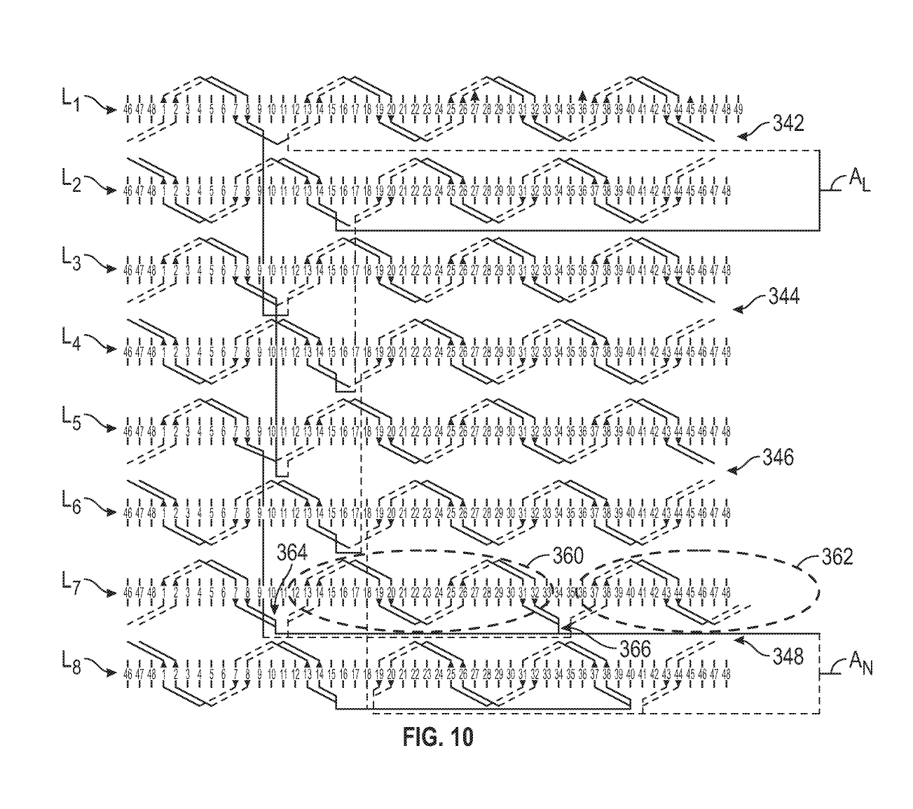

Referring to FIG. 10, an example winding layout for the electrical connections of FIG. 9 is shown, for a single phase. The numbers 1 through 48 refer to each stator slot, with the right side of the figure wrapping over or joining the left side of the figure. FIG. 10 shows the first through eighth conductor layers L₁, L₂, L₃, L₄, L₅, L₆, L₇ and L₈. The letters “A_{L}” and “A_{N}” in FIG. 10 refer to a phase A lead and a phase A neutral connection, respectively. As noted above, the fourth coil set 348 has the seventh and eighth conductors C317, C318 connected in a set of four parallel branches, resulting in 2 turns. Referring to FIG. 10, portion 360 and portion 362 in coil set 348 each show two turns being formed. Each of these portions, 360 and 362, have two coils of two turns in parallel. After forming the two turns in portion 360, the neutral lead A_{N} is configured to exit (about half way around the machine 12, as shown in FIG. 10), as shown by arrow 366, and the next two turns shown in portion 362 start. After forming the two turns in portion 362, the neutral lead A_{N} is configured to exit, as shown by arrow 364 (compare to portions 60 and 62 in FIG. 3).

While FIG. 10 indicates 48 stator slots in total, it is understood that the number of slots may be varied. The slot numbers are bracketed on the right by the letter “S” (such that numbers 1 through 48 refer to each stator slot), with the right side of the figure wrapping over or joining the left side of the figure. Alternative configurations may be made, as understood by those skilled in the art.

Referring to FIGS. 6 and 8, the assemblies 210, 310 may include uneven stator slots. Referring to FIG. 6, the assembly 210 includes a first stator teeth 225 positioned adjacent to and between the first stator slot 224 and the second stator slot 226. Referring to FIG. 8, the assembly 310 includes a first stator teeth 325 positioned adjacent to and between the first stator slot 324 and the second stator slot 326. The first stator slot 224, 324 is narrower near the slot openings. This provides the technical advantage of wider tooth near the slot opening and reduced levels of slot saturation.

Referring to FIG. 6, the first stator slot 224 has a first slot portion 251, a second slot portion 253 and a third slot portion 255, defining a first slot width 257, a second slot width 259 and a third slot width 261, respectively. The slot widths are substantially perpendicular to the slot axis SA. The second slot portion 253 is radially outwards of the first slot portion 251, and the third slot portion 255 is radially outwards of the second slot portion 253. The first slot width 257 is greater than the second slot width 259, and the second slot width 259 is greater than the third slot width 261

Referring to FIG. 8, the first stator slot 324 has a first slot portion 351 and a second slot portion 353, defining a first slot width 357, and a second slot width 359, respectively, each substantially perpendicular to the slot axis SA. The second slot portion 353 is radially outwards of the first slot portion 351. The first slot width 357 is greater than the second slot width 359.

The dimensions of the conductors and the stator slot may be selected as required for each particular application. The values may be derived through an optimization process performed using finite element analysis simulation tools or other modeling methods employed in the art. For example, the conductor lengths and widths may be selected based on the configuration that decreases torque ripple to the greatest extent while maintaining an acceptable torque output.

The detailed description and the drawings or FIGS. are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A stator assembly comprising:
a plurality of stator slots, including a first stator slot defining a slot axis;
a plurality of conductors at least partially positioned in the first stator slot and forming a winding set;
wherein the winding set includes at least one coil set with the plurality of conductors connected in series and at least one coil set with the plurality of conductors connected in parallel; and
wherein at least one of the plurality of conductors extends a first conductor length along the slot axis and at least another of the plurality of conductors extends a second conductor length along the slot axis, the first conductor length being different from the second conductor length.

2. The stator assembly of claim 1, wherein:
the plurality of conductors includes first, second, third, fourth, fifth, sixth, seventh and eighth conductors;
the first, second, third and fourth conductors each extend the first conductor length along the slot axis; and
the fifth, sixth, seventh and eighth conductors each extend the second conductor length along the slot axis.

3. The stator assembly of claim 2, wherein the winding set includes:
a first coil set with the first and second conductors connected in series;
a second coil set with the third and fourth conductors connected in series;
a third coil set with the fifth and sixth conductors connected in parallel; and
a fourth coil set with the seventh and eighth conductors connected in parallel.

4. The stator assembly of claim 2, wherein the winding set includes:
a first coil set with the first and second conductors connected in series;
a fourth coil set with the seventh and eighth conductors connected in parallel.

18. The stator assembly of claim 17, wherein:
the first stator slot has a third slot portion positioned radially outwards of the second slot portion, the third slot portion defining a third slot width substantially perpendicular to the slot axis; and
the second slot width is smaller than the third slot width.

19. A stator assembly comprising:
a plurality of stator slots, including a first stator slot defining a slot axis;
a plurality of conductors at least partially positioned in the first stator slot and forming a winding set;
wherein the winding set includes at least one coil set with the plurality of conductors connected in series and at least one coil set with the plurality of conductors connected in parallel; and
a neutral lead operatively connected to the plurality of conductors and configured to exit after about halfway around the machine.

20. The assembly of claim 19, wherein:
the plurality of conductors includes first, second, third, fourth, fifth, sixth, seventh and eighth conductors;
the winding set includes a first coil set with the first and second conductors connected in series, a second coil set with the third and fourth conductors connected in series, a third coil set with the fifth and sixth conductors connected in parallel and a fourth coil set with the seventh and eighth conductors connected in a set of four parallel branches; and
the fourth coil set is configured to form at least two turns and the neutral lead is configured to exit after the at least two turns.
a second coil set with the third and fourth conductors connected in series;
a third coil set with the fifth and sixth conductors and a fourth coil set with the seventh and eighth conductors;
wherein the third coil set and the fourth coil set are combined to have two parallel branches such that the fifth conductor and the seventh conductor form one of the two parallel branches and the sixth conductor and the eighth conductor form the other of the two parallel branches.

5. The stator assembly of claim 1, wherein:
the plurality of conductors includes first, second, third, fourth, fifth, sixth, seventh and eighth conductors;
the first through sixth conductors each extend the first conductor length along the slot axis; and
the seventh and eighth conductors each extend the second conductor length along the slot axis.

6. The stator assembly of claim 4, wherein the winding set includes:
a first coil set with the first and second conductors connected in series;
a second coil set with the third and fourth conductors connected in series;
a third coil set with the fifth and sixth conductors connected in series; and
a fourth coil set with the seventh and eighth conductors connected in parallel.

7. The assembly of claim 1, wherein:
the plurality of conductors includes first, second, third, fourth, fifth, sixth, seventh and eighth conductors;
the first through fourth conductors each extend the first conductor length along the slot axis;
the fifth and sixth conductors each extend the second conductor length along the slot axis; and
the seventh and eighth conductors each extend a third conductor length along the slot axis, the third conductor length being different from the first and second conductor lengths.

8. The stator assembly of claim 7, wherein the winding set includes:
a first coil set with the first and second conductors connected in series;
a second coil set with the third and fourth conductors connected in series;
a third coil set with the fifth and sixth conductors connected in parallel; and
a fourth coil set with the seventh and eighth conductors connected in parallel.

9. The assembly of claim 1, wherein:
the first stator slot having a first slot portion and a second slot portion such that the second slot portion is radially outwards of the first slot portion;
the first slot portion defines a first slot width substantially perpendicular to the slot axis; and
the second slot portion defines a second slot width substantially perpendicular to the slot axis, the first slot width being smaller than the second slot width.

10. The assembly of claim 9, wherein:
the first stator slot has a third slot portion positioned radially outwards of the second slot portion, the third slot portion defining a third slot width substantially perpendicular to the slot axis; and
the second slot width is smaller than the third slot width.

11. A stator assembly comprising:
a plurality of stator slots, including a first stator slot defining a slot axis;
a plurality of conductors at least partially positioned in the first stator slot and forming a winding set;
wherein the first stator slot has a first slot portion and a second slot portion such that the second slot portion is radially outwards of the first slot portion;
wherein the winding set includes at least one coil set with the plurality of conductors connected in series and at least one coil set with the plurality of conductors connected in parallel; and
wherein at least one of the plurality of conductors extends a first conductor length along the slot axis and at least another of the plurality of conductors extends a second conductor length along the slot axis, the first conductor length being different from the second conductor length;
wherein the first slot portion defines a first slot width substantially perpendicular to the slot axis; and
wherein the second slot portion defines a second slot width substantially perpendicular to the slot axis, the first slot width being smaller than the second slot width.

12. The stator assembly of claim 11, wherein:
the plurality of conductors includes first, second, third, fourth, fifth, sixth, seventh and eighth conductors;
the first, second, third and fourth conductors each extend the first conductor length along the slot axis; and
the fifth, sixth, seventh and eighth conductors each extend the second conductor length along the slot axis.

13. The stator assembly of claim 12, wherein the winding set includes:
a first coil set with the first and second conductors connected in series;
a second coil set with the third and fourth conductors connected in series;
a third coil set with the fifth and sixth conductors connected in parallel; and
a fourth coil set with the seventh and eighth conductors connected in parallel.

14. The stator assembly of claim 11, wherein:
the plurality of conductors includes first, second, third, fourth, fifth, sixth, seventh and eighth conductors;
the first through sixth conductors each extend the first conductor length along the slot axis; and
the seventh and eighth conductors each extend the second conductor length along the slot axis.

15. The stator assembly of claim 14, wherein the winding set includes:
a first coil set with the first and second conductors connected in series;
a second coil set with the third and fourth conductors connected in series;
a third coil set with the fifth and sixth conductors connected in series; and
a fourth coil set with the seventh and eighth conductors connected in parallel.

16. The assembly of claim 11, wherein:
the plurality of conductors includes first, second, third, fourth, fifth, sixth, seventh and eighth conductors;
the first through fourth conductors each extend the first conductor length along the slot axis;
the fifth and sixth conductors each extend the second conductor length along the slot axis; and
the seventh and eighth conductors each extend a third conductor length along the slot axis, the third conductor length being different from the first and second conductor lengths.

17. The stator assembly of claim 16, wherein the winding set includes:
a first coil set with the first and second conductors connected in series;
a second coil set with the third and fourth conductors connected in series;
a third coil set with the fifth and sixth conductors connected in parallel; and
